(19) United States
(12) Patent Application Publication
(10) Pub. No.: US 2009/0122403 A1
(43) Pub. Date: May 14, 2009

(54) OPTICAL FILM WITH LOW OR ZERO BIREFRINGENCE AND METHOD FOR FABRICATING THE SAME

(75) Inventors: Chieh-Fu Lu, Kaohsiung County (TW); Shih-Jung Tsai, Hsinchu City (TW); Jui-Hsiang Liu, Tainan City (TW); Kuo-Chen Shih, Kaohsiung City (TW)

Correspondence Address: JIANQ CHYUN INTELLECTUAL PROPERTY OFFICE, 7 FLOOR-1, NO. 100, ROOSEVELT ROAD, SECTION 2, TAIPEI, 100, TW

(73) Assignee: INDUSTRIAL TECHNOLOGY RESEARCH INSTITUTE, Hsinchu (TW)

(21) Appl. No.: 12/022,119

(22) Filed: Jan. 29, 2008

(30) Foreign Application Priority Data
Nov. 8, 2007 (TW) 96142184

(51) Int. Cl. G02B 5/30

(52) U.S. Cl. 359/499

(57) ABSTRACT

An optical film with low or zero birefringence and a method for fabricating the same are provided. The optical film with low or zero birefringence includes a plurality of birefringence films, and the plurality of birefringence films is overlapped with the long axes perpendicular to each other. A sum of the refractive indices of the overlapped birefringence films in an x direction is equal to that in a y direction. The placement of the birefringence films in the optical film with low or zero birefringence can solve the problem that optical polymer cannot be applied to optical parts due to the birefringence of optical polymer.

### CROSS-REFERENCE TO RELATED APPLICATION

This application claims the priority benefit of Taiwan application serial no. 96142184, filed on Nov. 8, 2007. The entirety of the above-mentioned patent application is hereby incorporated by reference herein and made a part of this specification.

### BACKGROUND OF THE INVENTION

1. Field of the Invention

The present invention relates to an optical film with low or zero birefringence and a fabrication method thereof.

2. Description of Related Art

Polymer material has the properties about light weight, a variety of types and so on. In recent years, the polymer material has gradually replaced the conventional glass material in the applications of video recorders and optical pickup heads due to the characteristics of light weight and impact resistance. Besides, the polymer materials may be easily formed by, for example, the extrusion or injection molding process, which can also be used in polymer product processing. In current liquid crystal displays (LCDs), major components of the LCDs are mainly made of the glass material. However, along with the application of LCDs in various working environments, major components of LCDs are required to be light and thin, and are also required to have improved performance such as the impact resistance. The above properties of the polymer material can meet the application requirements of the LCDs.

Although the polymer material has the aforementioned superior properties and the application potential in the optical parts, in fact, the polymer material has not been fully used in various optical parts since the products made of the optical polymer materials formed by the above forming and processing techniques have birefringence, which will greatly influence the practical application of the optical parts, and further influences the functions of the optical parts.

The birefringence of the polymer material and the cause thereof are known to all. In other words, generally speaking, for almost all polymer materials used as optical materials, the monomers forming the polymer are optically anisotropic with refractive indices. The optical anisotropy of the monomers is arranged in a certain direction on the polymer, i.e., the alignment makes the polymer materials to generate birefringence. The birefringence will cause serious problems in the application of polarization, for example, in the application of the optical parts of the writing/erasing optical disks developed in recent years. If the writing/erasing optical disk uses a polarized light beam to read and write, the reading or writing precision will be influenced due to the optical property of the birefringence in the optical path (the optical disk and reading lens). In the application of LCD products, the structure of a liquid crystal display element has a liquid crystal layer between a polarizer or the polarizer of a parallel polarizer and a polarization analyzer, and the liquid crystal layer rotates the polarized wave surface of the polarized light, so as to control light transmission. Therefore, the birefringence of the components in the liquid crystal display elements will generate severe influence, which widely obstructs the application of the polymer optical materials in the liquid crystal display elements.

The so-called “optical isotropy” refers to that the optical properties such as refractive index and light absorption of a certain substance are the same in all directions, and the properties are not related to the directions. Comparatively, the “optical anisotropy” refers to that the optical properties of the substance vary in different directions, and thus the substance has birefringence. Strictly speaking, only few materials are optically isotropic, and even transparent or partially transparent polymer material such as polyethylene or polymethylmethacrylate are not totally optically isotropic, and the birefringence indices thereof are not zero. Furthermore, even if the polymer material is totally optically isotropic, the polymer material may suffer a stress generated in a flowing direction of the polymer material after extrusion or injection molding processes, or the polymer material may be distorted after drawing. Thus, the arrangement of the molecules has orientation, thereby resulting in the birefringence of the materials.

In order to reduce/compensate the aforementioned orientation birefringence, a variety of methods are provided. For example, PCT/JP95/01635 (International Publication No. WO96/06370) uses a transparent polymer resin (such as PMMA and PC) as a substrate, and adds a low molecular organic substance which may be oriented with the extrusion or injection molding procedures of a high molecular substrate. The birefringence properties of the low molecular organic substance must be different from that of the high molecular substrate, so as to reduce/compensate the birefringence of the high molecular substrate generated by the orientation, thereby obtaining an optical polymer resin material with low or zero birefringence. However, the high molecular substrate with zero birefringence fabricated in this manner will produce a plasticizing effect due to the addition of the low molecular organic substance. Therefore, the thermal resistance of the high molecular substrate is reduced and the air isolation becomes worse.

U.S. Pat. No. 4,785,053 discloses a co-polymerized material of methyl methacrylate and styrene having positive and negative birefringence monomers. The co-polymerized polymer is subjected to the injection molding process to obtain an optical polymer material with low birefringence. However, the physical properties such as glass transition temperature (Tg) of the polymer material with low birefringence manufactured in this manner is hard to control.

PCT/JP00/06880 (International Publication No. WO01/25364) uses a transparent high molecular resin (such as PMMA and PC) as a substrate, and adds an inorganic fine substance having birefringence. The inorganic substance, such as mineral crystal, mostly has birefringence much greater than that of an organic compound. Particularly, the crystals having the birefringence are arranged to have anisotropy, which is not like to the polymer that has birefringence generated by the drawing orientation. Therefore, the inorganic substance having the birefringence is added to reduce/compensate the birefringence of the polymer substrate generated by the orientation, thereby achieving an optical polymer substrate with low or zero birefringence. However, this method has the inorganic particle dispersing and light scattering problems. The light scattering may occur if the difference between two refractive indices is greater than 0.5 or the size of the inorganic particles is greater than 100 nm. Therefore, the transparency will also be lowered.

### SUMMARY OF THE INVENTION

Accordingly, the present invention is directed to provide an optical film with low or zero birefringence, so as to solve the birefringence problem generated when the polymer material is applied in the optical parts. Meanwhile, the birefringence of the polymer when applied in the optical parts may be zero or approximate to zero without influencing the physical properties of the polymer material and generating adverse affects on the practical application.

The present invention is further directed to provide a method of fabricating an optical film with low or zero birefringence, so as to solve the problem that the optical polymer material cannot be applied in optical parts due to the birefringence.

The present invention provides an optical film with low or zero birefringence, which includes multiple birefringence films. The birefringence films are overlapped with long axes perpendicular to each other, and a sum of the refractive indices of the overlapped birefringence films in an x direction is equal to that in a y direction.

The present invention further provides a method of fabricating an optical film with low or zero birefringence, which includes overlapping multiple birefringence films while making the long axes of the birefringence films be perpendicular to each other. A sum of the refractive indices of the overlapped birefringence films in an x direction is equal to that in a y direction.

In the present invention, the material with low or zero birefringence is achieved by the complementary property of the refractive indices of the materials, in which two or more optical films with same or different birefringence indices are overlapped with the long axes perpendicular to each other, such that the refractive index is approximate to zero. Therefore, the birefringence of the optical film caused by drawing effects or non-uniform stress distribution resulted from processing way will be reduced when the optical film is prepared by the extrusion and injection molding process.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a schematic three-dimensional view of an optical film with low or zero birefringence according to the first embodiment of the present invention.

FIGS. 2A to 2B are the top views of processes of fabricating the optical film with low or zero birefringence according to the second embodiment of the present invention.

FIGS. 3A to 3C are curve diagrams of rotation angles versus transmittance in different regions in FIG. 2B.

FIG. 4 is a flow chart of processes of fabricating an optical film with low or zero birefringence according to the third embodiment of the present invention.

FIGS. 5A to 5C are top views of processes and partially enlarged views of the optical film with low or zero birefringence according to the third embodiment.

FIG. 6 is a flow chart of processes of fabricating an optical film with low or zero birefringence according to the fourth embodiment of the present invention.

### DESCRIPTION OF THE EMBODIMENTS

Reference will now be made in detail to the present preferred embodiments of the invention, examples of which are illustrated in the accompanying drawings. Wherever possible, the same reference numbers are used in the drawings and the description to refer to the same or like parts.

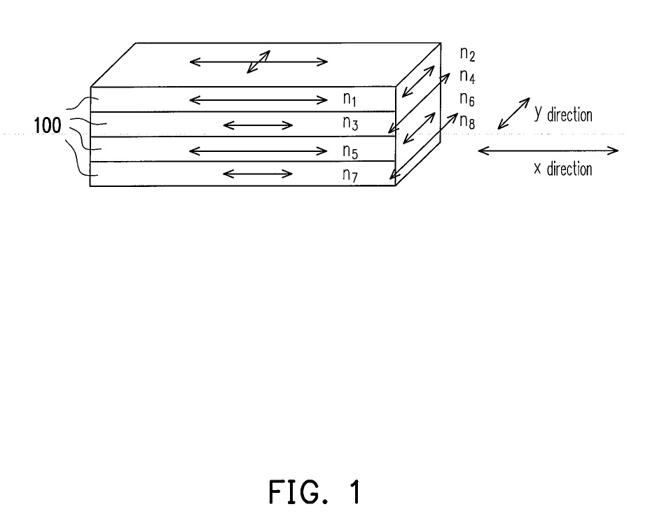

FIG. 1 is a schematic three-dimensional view of the optical film with low or zero birefringence according to the first embodiment of the present invention. Referring to FIG. 1, the optical film with low or zero birefringence in the first embodiment includes multiple birefringence films 100, which have birefringence indices n₁/n₂, n₄/n₃, n₅/n₆, and n₈/n₇ in the long axes and short axes. The birefringence films are overlapped with long axes perpendicular to each other, and a sum of the refractive indices may be balanced out, i.e., the sum (n₁+n₃+n₅+n₇) of the refractive indices in an x direction is equal to the sum (n₂+n₄+n₆+n₈) of the refractive indices in a y direction, so an isotropic optical film is formed after the birefringence films 100 are overlapped. In theory, the overlapped optical films with low or zero birefringence have optical isotropy. However, in the first embodiment, four birefringence films 100 are overlapped. However, the number of the birefringence films 100 may be more or less according to the materials, optical properties, or other considerations. For example, in consideration of the thickness of the films, the number of the birefringence films 100 may be set to 2 to 6. Furthermore, the birefringence films 100 may be the thin films having the same long axis refractive indices and the same short axis refractive indices, or may be the thin films having different long axis refractive indices and the different short axis refractive indices. In addition, the optical film with low or zero birefringence in the first embodiment may be further constituted by the same birefringence films or different birefringence films.

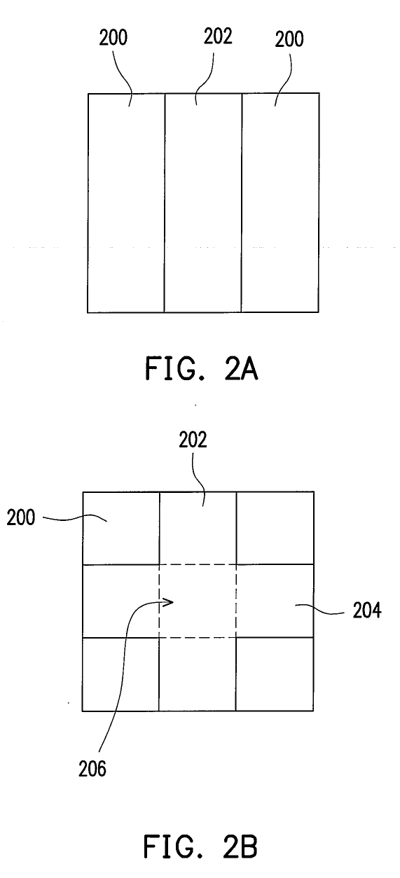

FIGS. 2A to 2B are the top views of processes of fabricating the optical film with low or zero birefringence according to the second embodiment of the present invention.

Firstly, referring to FIG. 2A, a birefringence film 202 is provided on a substrate 200, which, for example, is a glass substrate. The material of the birefringence film 202 is, for example, common polymer material, or a polymer film added with liquid crystals or other organic or inorganic materials. The film having a birefringence index may be fabricated by an anisotropic drawing process, and the forming method is, for example, coating, adhering, and other suitable methods.

Then, referring to FIG. 2B, another birefringence film 204 is overlapped, and the long axes of the birefringence films 202 and 204 are perpendicular to each other. The sum of the refractive indices of the overlapped birefringence films 202 and 204 in an x direction must be equal to the sum of the refractive indices in a y direction. As such, the optical film with low or zero birefringence prepared in the second embodiment is the overlapped portion 206 of the birefringence films 202 and 204.

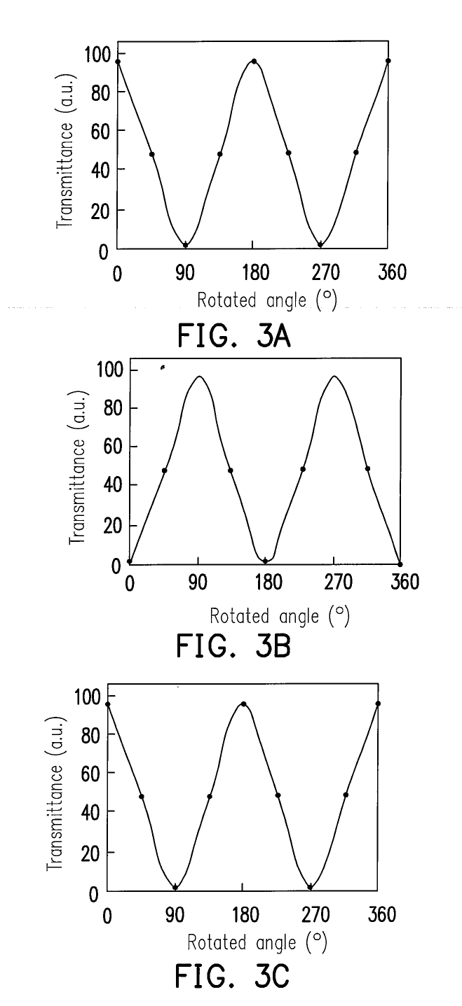

FIGS. 3A to 3C are curve diagrams of rotation angles versus transmittance in different regions in FIG. 2B.

Firstly, referring to FIG. 3A, a region (for example, the top left portion of the overlapped portion 206) with no birefringence film overlapped thereon in FIG. 2B is shown. Therefore, in the parallel polarization state, when the rotation angle is 0 degrees, a high transmittance is presented. When the rotation angle is 90 degrees, the low transmittance is presented.

Then, referring to FIG. 3B, a region (for example, the above portion of the overlapped portion 206) with one birefringence films overlapped thereon is shown. Therefore, in the parallel polarization state, when the rotation angle is 0 degrees, the low transmittance of the material is presented, and when the rotation angle is 90 degrees, the high transmittance is presented. At this point, because of the optical properties of the birefringence films, the variation of the transmittance is just reverse to the region just with the substrate.

Then, referring to FIG. 3C, an overlapped region (i.e., the overlapped portion 206) of two birefringence films in FIG. 2B is shown. Therefore, in the parallel polarization state, when the rotation angle is 0 degrees, a high transmittance of the material is presented, and when the rotation angle is 90 degrees, a low transmittance is presented.

Based on the comparison between FIG. 3A and FIG. 3C, the curve diagrams of the rotation angles versus to the transmittance are the same. That is to say, the performance of the transmittance of the overlapped portion 206 in FIG. 2B is consistent with that of the overlapped portion 206 just with the substrate 200. In brief, the optical film with low or zero birefringence fabricated according to the second embodiment has the optical property of optical isotropy.

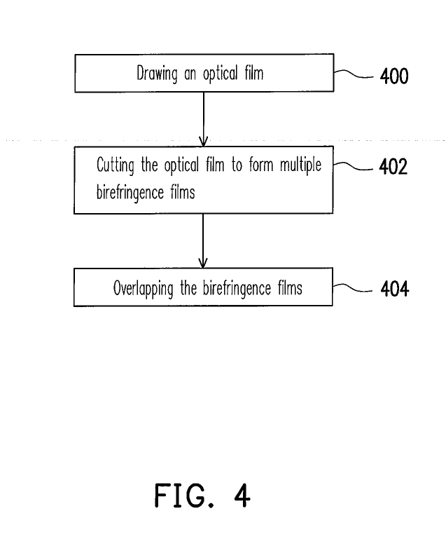

FIG. 4 is a flow chart of processes of fabricating an optical film with low or zero birefringence according to the third embodiment of the present invention.

Referring to FIG. 4, Step 400 is firstly performed to draw the optical film. In this process, an anisotropic drawing process is performed on a transparent polymer material or a polymer film added with liquid crystals or other organic/inorganic materials, and one kind of optical films or different kinds of optical films may be drawn.

Then, Step 402 is performed to cut the optical film so as to form multiple birefringence films. If only one kind of optical films are used, the identical multiple birefringence films may be formed after the cutting process. If various kinds of optical films are used, the optical films must be cut respectively to form different multiple birefringence films.

Thereafter, Step 404 is performed to overlap the birefringence films while making the long axes of the birefringence films be perpendicular to each other. The sum of the refractive indices of the overlapped birefringence films in an x direction must be equal to the sum of the refractive indices in a y direction. The number of the birefringence films is, for example, 2 to 6. Furthermore, the method of overlapping the birefringence films is, for example, directly pressing the birefringence films or bonding the birefringence films with an adhesive, thereby forming the optical polymer film material with low or zero birefringence. Further, the dried adhesive has a small thickness, which will not influence the refractive ability of the optical film.

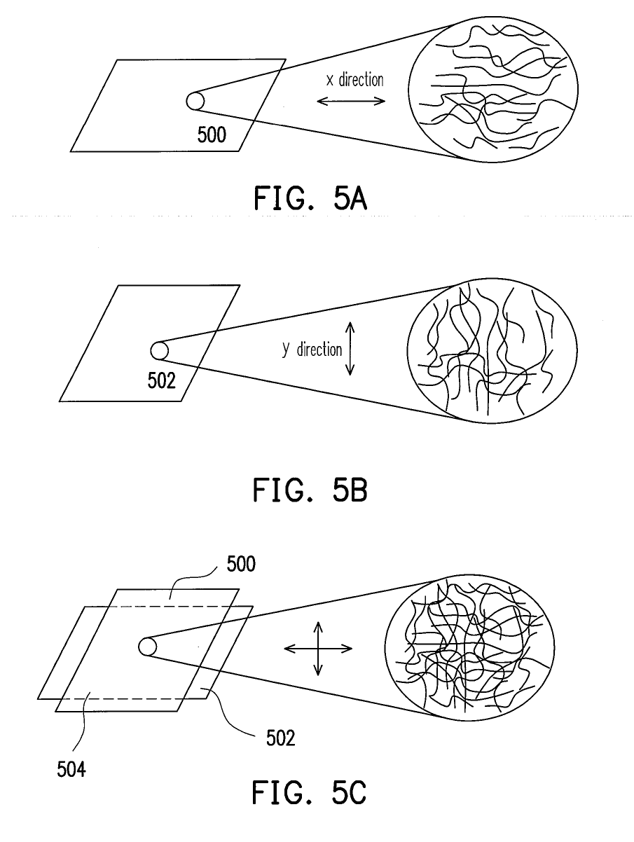

FIGS. 5A to 5C are top views of the processes and partially enlarged views of the optical film with low or zero birefringence according to the third embodiment.

Firstly, referring to FIG. 5A, the left side is a birefringence film 500, and the right side is the partially enlarged view of birefringence film 500. From the partially enlarged view, it can be seen that the birefringence film 500 is drawn in a direction along the two sides of the x direction. That is to say, the long-axis direction of the birefringence films 500 is the x direction, and the short-axis direction is the y direction (not shown).

Then, referring to FIG. 5B, the left side is another birefringence film 502, and the right side is the partially enlarged view of the birefringence film 502. From the partially enlarged view, it can be seen that the birefringence film 502 is drawn in a direction along the two sides of the y direction. That is to say, the long-axis direction of the birefringence films 502 is the y direction, and the short-axis direction is the x direction (not shown).

After that, referring to FIG. 5C, when the birefringence films 500 and the birefringence films 502 are overlapped, the partially enlarged view of the overlapped portion 504 is on the right side of the figure. From the partially enlarged view, it can be seen that the overlapped portion is an isotropic optical film.

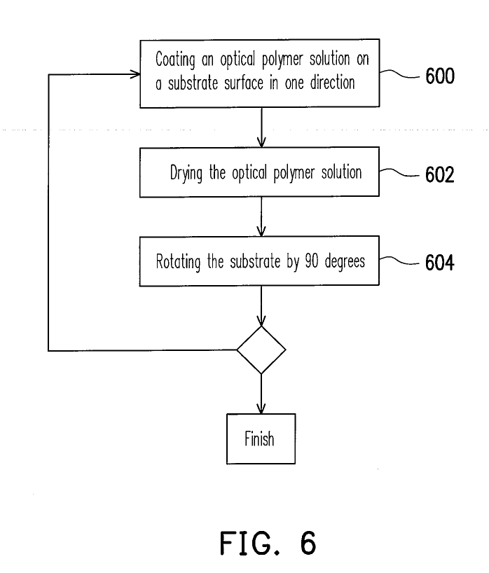

FIG. 6 is a flow chart of processes of fabricating an optical film with low or zero birefringence according to the fourth embodiment of the present invention. Referring to FIG. 6, Step 600 is firstly performed to coat an optical polymer solution on the surface of a substrate in one direction. The optical polymer solution is, for example, a solvent-volatile type polymer solution or a light-curing polymer solution. When the optical polymer solution is a light-curing polymer solution, the optical polymer solution may be irradiated to be cured by the linearly polarized UV light, thereby having birefringence.

Then, Step 602 is performed to dry the optical polymer solution. The drying method is air dry, baking, or other suitable methods. Afterwards, Step 604 is performed to rotate the substrate by 90 degrees. The, Steps 600 to 604 are repeated at least once. In the fourth embodiment, the time of repeating Steps 600 to 604 is 1 to 5, for example.

In the fourth embodiment, the film is coated substantially in one direction. The film material is coated on the substrate and then dried. The substrate is rotated by 90 degrees, and then the film material is coated again. When the material is coated in one direction, the directional arrangement of the film material may be formed, thereby causing birefringence. In theory, the birefringence may be balanced out by rotating the material by 90 degrees and coating the film material again, like the drawing system in the third embodiment, thereby obtaining the optical film with low or zero birefringence.

To sum up, in the present invention, an optical film with low or zero birefringence is formed by overlapping two or more birefringence films. In the method of the present invention, the processes are simplified, the physical properties of the polymer substrate will not be influenced, and the substances free of additives may be uniformly distributed. Also, the problems of light scattering and low transparency can be solved. Meanwhile, the transparent polymer substrate has the characteristic of low or zero birefringence, and has business value and competition advantage.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. An optical film with low or zero birefringence, comprising:
a plurality of birefringence films, wherein
the plurality of birefringence films is overlapped with long axes thereof perpendicular to each other; and
a sum of refractive indices of the overlapped birefringence films in an x direction is equal to that in a y direction.

2. The optical film with low or zero birefringence as claimed in claim 1, wherein a number of the plurality of birefringence films is 2 to 6.

3. The optical film with low or zero birefringence as claimed in claim 1, wherein all of the plurality of birefringence films are identical.

4. The optical film with low or zero birefringence as claimed in claim 1, wherein all of the plurality of birefringence films are different.

5. The optical film with low or zero birefringence as claimed in claim 1, wherein the plurality of birefringence films comprises identical films and different films.

6. A method of fabricating an optical film with low or zero birefringence, comprising:
overlapping a plurality of birefringence films while making long axes of the birefringence films perpendicular to each other, wherein a sum of refractive indices of the overlapped birefringence films in an x direction is equal to that in a y direction.

7. The method of fabricating an optical film with low or zero birefringence as claimed in claim 6, before the step of overlapping the birefringence films, further comprising:
drawing various kinds of optical films; and
cutting the optical films respectively, so as to form different birefringence films.

8. The method of fabricating an optical film with low or zero birefringence as claimed in claim 7, wherein a process of overlapping the birefringence films comprises directly pressing the birefringence films or bonding the birefringence films with an adhesive.

9. The method of fabricating an optical film with low or zero birefringence as claimed in claim 6, before the step of overlapping the birefringence films, further comprising:
drawing an optical film; and
cutting the optical film, so as to form identical birefringence films.

10. The method of fabricating an optical film with low or zero birefringence as claimed in claim 9, wherein a process of overlapping the birefringence films comprises directly pressing the birefringence films or bonding the birefringence films with an adhesive.

11. The method of fabricating an optical film with low or zero birefringence as claimed in claim 6, wherein a number of the plurality of birefringence films is 2 to 6.

12. The method of fabricating an optical film with low or zero birefringence as claimed in claim 6, wherein the process of overlapping the birefringence films comprises:
a) coating an optical polymer solution on a substrate surface in one direction;
b) drying the optical polymer solution;
c) rotating the substrate by 90 degrees; and
repeating the steps a to c at least once.

13. The method of fabricating an optical film with low or zero birefringence as claimed in claim 12, wherein a time of repeating the steps a to c is 1 to 5.

14. The method of fabricating an optical film with low or zero birefringence as claimed in claim 12, wherein the optical polymer solution comprises a solvent-volatile type polymer solution or a light-curing polymer solution.

15. The method of fabricating an optical film with low or zero birefringence as claimed in claim 14, wherein the light-curing polymer solution is irradiated to be cured by a linearly polarized UV light, so as to possess birefringence.
